(19) United States
(12) Patent Application Publication
(10) Pub. No.: US 2022/0184522 A1
(43) Pub. Date: Jun. 16, 2022

(54) MONOBLOC ASSEMBLY FOR A DEVICE WHICH CAN CARRY OUT TRANSFER OF HEAT

(71) Applicants: GRIMS, VILLETTE D'ANTHON (FR); INSTITUT NATIONAL POLYTECHNIQUE DE TOULOUSE, TOULOUSE (FR); CENTRE NATIONAL DE LA RECHERCHE SCIENTIFIQUE - CNRS -, PARIS (FR)

(72) Inventors: Michel MEYER, TOULOUSE CEDEX 4 (FR); David ROUZINEAU, TOULOUSE CEDEX 4 (FR); Cyrille GRIMAUD, Mauguio (FR); Jacques Louis BOUSQUET, IRIGNY (FR)

(73) Assignees: GRIMS, VILLETTE D'ANTHON (FR); INSTITUT NATIONAL POLYTECHNIQUE DE TOULOUSE, TOULOUSE (FR); CENTRE NATIONAL DE LA RECHERCHE SCIENTIFIQUE - CNRS -, PARIS (FR)

(21) Appl. No.: 17/432,210

(22) PCT Filed: Feb. 20, 2020
(86) PCT No.: PCT/FR2020/050322

§ 371 Date: Aug. 19, 2021

(30) Foreign Application Priority Data
Feb. 20, 2019 (FR) 1901686

(51) Int. Cl. B01D 3/32; F25J 3/04; F25J 5/00; F28D 21/00; F28F 13/00; B01D 3/26

(52) U.S. Cl. CPC B01D 3/32; F25J 3/0463; F25J 3/04939; F25J 5/007; F28D 2021/0033; F28F 13/003; B01D 3/26; F25J 2200/80; F25J 2200/96; F28D 21/0015

(57) ABSTRACT

A method for transfer of heat between a first and a second fluid, wherein the first and the second fluid circulate respectively on both sides of a thermally conductive wall of a monobloc assembly formed in a single piece. The monobloc assembly, which is arranged in the interior of a device, includes: a first, three-dimensional, cellular, thermally conductive structure through which the first fluid can pass; at least the thermally conductive wall; and a second, three-dimensional, cellular, thermally conductive structure through which the second fluid can pass. The first and second three-dimensional, cellular structures are situated on both sides of and integral with the wall such that heat transfer is carried out from the first to the second fluid through the wall, and both first and second fluids are under liquid phases and under gaseous phases, with the liquid phases circulating in a direction opposite that of the gaseous phases.

The present invention relates to the field of devices which can carry out transfer of heat.

The reduction of energy consumption of industrial processes which are designed to carry out separations of various, finished or intermediate compounds required by different types of industries which use fossil or renewable resources is a major factor, for example in the case of columns for distillation, absorption or stripping. In particular, when the levels of volatility of the bodies to be separated are close, the energy requirement of a column for distillation, absorption or stripping increases, and the energy efficiency of the separation process decreases.

Many designs for distillation columns have been proposed since the beginning of the industrial era, and, more recently, the concept of “Heat Integrated Distillation Columns”, known as HIDiC columns, has been developed.

The characteristic of an HIDiC column is that the heat is transferred from a hot enrichment area, to a colder, impoverishment area. In order to be able to observe this situation, the enrichment area is regulated to a pressure greater than the impoverishment area. The pressure jump to be implemented is slight, which minimizes the recompression costs. In other words, the pressure jump necessary for the economic implementation of an HIDiC column means that the energy cost of this recompression must be lower than that of the energy consumption of a conventional distillation column, said consumption of which is measured at the re-boiler thereof. Nevertheless, it continues to be difficult to combine high-energy integration and efficiency of separation.

There is therefore a need for devices to reduce the energy consumption which can carry out transfer of heat highly efficiently.

The invention achieves this objective thanks to a method for transfer of heat between a first and a second fluid, wherein the first and the second fluid circulate respectively on both sides of a thermally conductive wall of a monobloc assembly formed in a single piece, which assembly is arranged in the interior of a device, the monobloc assembly comprising:
a first, three-dimensional, cellular, thermally conductive structure through which the first fluid can pass;
at least said wall; and
a second, three-dimensional, cellular, thermally conductive structure through which the second fluid can pass;
   the first, three-dimensional, cellular structure and the second, three-dimensional, cellular structure being situated on both sides of said wall and being integral with said wall;

such that the transfer of heat is carried out from the first fluid to the second fluid through said wall, and each of the first and second fluids is in particular both under liquid phase and under gaseous phase, with the liquid phase of the first fluid circulating in a direction opposite that of the gaseous phase of the first fluid, and the liquid phase of the second fluid circulating in a direction opposite that of the gaseous phase of the second fluid.

In other words, each of the first and second fluids is in particular at the same time under liquid phase and under gaseous phase, with the liquid phase of the first fluid circulating counter to the gaseous phase of the of the first fluid, and the liquid phase of the second fluid circulating counter to the gaseous phase of the second fluid.

The speed of the gaseous phase of each of the first and second fluids is between 0.5 m/s and 5 m/s, preferably between 1 m/s and 3 m/s.

The first fluid corresponds in particular to a first counter-current flow and the second fluid corresponds to a second counter-current flow. More particularly, the first fluid corresponds in particular to a first counter-current flow in gas-liquid bi-phase form, and the second fluid corresponds to a second counter-current flow in gas-liquid bi-phase form.

Material is transferred simultaneously with the transfer of heat.

Transfer of material into each of the three-dimensional structures is carried out simultaneously with the transfer of heat.

Thus, the method according to the invention is distinguished in that the transfer of heat and the transfer of material take place simultaneously within the device. In the interior of the two structures, each of the two fluids is at the same time under liquid phase and under gaseous phase. The liquid flows on the solid surface, whereas the gas occupies the remainder of the structure. In order to ensure optimal contact between the two phases, the structure must be entirely wetted, and at the same time the gas must circulate in all of the structure, without following a preferential path. This is made possible by the three-dimensional cellular architecture of each of the structures, which has a large area of interface, and thus makes it possible to create a large contact surface between the two phases.

In addition, the monobloc assembly formed in a single piece makes the transfer of heat more efficient. In the absence of continuity between the three-dimensional cellular structures and the thermally conductive wall, the energy is diffused in the interior of each of the structures, thus limiting considerably the transfer of heat through the wall. In the inverse case, when the monobloc assembly is formed in a single piece according to the invention, there is continuity of material between the three-dimensional cellular structures and the thermally conductive wall, thus permitting the transfer of heat through said wall.

The subject of the invention is also a device which can carry out transfer of heat between a first and a second fluid circulating respectively on both sides of a thermally conductive wall, said device being configured to implement the method previously described, the device comprising a monobloc assembly formed in a single piece, comprising:
a first, three-dimensional, cellular, thermally conductive structure through which the first fluid can pass;
at least said wall; and
a second, three-dimensional, cellular, thermally conductive structure through which the second fluid can pass;
   the first, three-dimensional, cellular structure and the second, three-dimensional, cellular structure being situated on both sides of said wall and being integral with said wall;
   such that the transfer of heat is carried out from the first fluid to the second fluid through said wall.

The monobloc assembly guarantees good thermal performance levels. In the case of use of a distillation column, it also guarantees good separation performance levels.

According to the invention, “monobloc” means an assembly formed in a single piece, with the first, three-dimensional cellular structure and the second, three-dimensional cellular structure both being inseparable from the wall.

The device can be a heat exchanger or a separation column, in particular a distillation column, an absorption column or a stripper.

The device can be a heat exchanger.

The device can transfer material simultaneously with the transfer of heat. The device thus improves the exchanges of heat, while conserving the performance levels of transfer of material. The performance levels of transfer of material are in particular necessary for implementation of separation processes in many industries of transformation of various chemical, energy, foodstuffs and biotechnological materials. “Performance levels of transfer of material” thus means the separation of material, which is the very purpose of a distillation column, an absorption column, or a stripper.

The device can be a separation column, in particular a distillation column, an absorption column or a stripper, or two reactive separation columns, with one producing heat and the other consuming it. A device of this type makes it possible to improve very significantly the performance levels of the processes of distillation, absorption or stripping, which are separation processes within which it is important to control simultaneously the processes of transfer of material and heat. These processes play an important part in the petroleum, gas, petrochemical and chemical industries, and particularly in installations which are designed for processing of natural gas, for deacidification for example, or of combustion gas, for de-alkalization for example, for which control of the energy consumption must be minimized.

Preferably, the device is a distillation column or a heat exchanger, in particular a distillation column. Even more preferably, the device is a distillation column comprising a heat exchanger which is configured to exchange heat between two bi-phase fluids, in particular each containing a liquid phase and a gaseous phase.

The distillation column comprises one or a plurality of monobloc assemblies according to the invention, configured such that the length of the distillation column is equal to a target length. The monobloc assemblies can be screwed and/or glued to one another.

The device can be an HIDiC distillation column.

In particular, the HIDiC distillation column comprises an enrichment area and an impoverishment area, in which the first fluid and the second fluid circulate respectively. In particular, the wall of the monobloc assembly separates the enrichment area from the impoverishment area.

The device improves the exchanges of heat between the enrichment area and the impoverishment area, while conserving the performance levels of transfer of material in each of said areas.

The device can be a concentric HIDiC distillation column. The concentric HIDiC column according to the invention has a high level of energy saving, in particular for separation of compounds with close volatility.

“Concentric HIDiC distillation column” means an HIDiC distillation column comprising a concentric enrichment column and a concentric impoverishment column. In other words, the enrichment area is an enrichment column, and the impoverishment area is an impoverishment column, the enrichment column and the impoverishment column being concentric.

In particular, the enrichment column comprises the first, three-dimensional, cellular, thermally conductive structure.

In particular, the impoverishment column comprises the second, three-dimensional, cellular, thermally conductive structure.

The difference in temperature between the head and the foot of the distillation column can be 20° C. or less. The slighter the temperature difference between the head and the foot of the distillation column, the greater the energy saving is.

The operation of a distillation column according to the invention is thus distinguished in that, firstly there is transfer of material between the phases in each fluid, and secondly the transfer of heat between the two fluids is assured in the most efficient manner possible. Material is thus transferred simultaneously with the transfer of heat.

The device is configured such that each of the first and second fluids is both under liquid phase and under gaseous phase, with the liquid phase of the first fluid circulating in a direction opposite that of the gaseous phase of the first fluid, and the liquid phase of the second fluid circulating in a direction opposite that of the gaseous phase of the second fluid. Thus, a gas/liquid counter-current flow can be observed on both sides of the wall.

The device is configured such that the speed of the gaseous phase of each of the first and second fluids is between 0.5 m/s and 5 m/s, preferably between 1 m/s and 3 m/s.

In particular, the invention can be used for fractionated distillation in fields such as refinery, petrochemicals, specialized chemistry, and the pharmaceuticals, biotechnology or foodstuffs industries.

According to another one of its objectives, the invention relates to a monobloc assembly which is designed for implementation of a method as previously described, said monobloc assembly being designed to be arranged in the interior of a device as described above, which device can carry out transfer of heat between a first and a second fluid circulating respectively on both sides of a thermally conductive wall, said monobloc assembly being formed in a single piece and comprising:
a first, three-dimensional, cellular, thermally conductive structure through which the first fluid can pass;
at least said wall; and
a second, three-dimensional, cellular, thermally conductive structure (4) through which the second fluid can pass;
   the first, three-dimensional, cellular structure and the second, three-dimensional, cellular structure being situated on both sides of said wall and being integral with said wall;
   such that the transfer of heat is carried out from the first fluid to the second fluid through said wall.

The monobloc assembly guarantees good thermal performance levels. In the case of use in a distillation column, it also guarantees good separation performance levels.

According to the invention, “monobloc assembly” means an assembly formed in a single piece, the first, three-dimensional, cellular structure and the second, three-dimensional, cellular structure being inseparable from the wall.

The wall preferably has a cylindrical form.

The wall has a thickness of between 0.5 mm and 10 mm.

The first, three-dimensional, cellular structure and the second, three-dimensional, cellular structure can be molded in a single piece with the wall, in particular by casting.

Alternatively, the monobloc assembly can be produced by additive production, by brazing or by welding of elementary metal plates.

The device can transfer material simultaneously with the transfer of heat.

The device can transfer material within the first and second fluids simultaneously with the transfer of heat.

The first three-dimensional, cellular, thermally conductive structure fills the interior of the cylinder formed by the wall, and in particular has a radius of between 15 mm and 50 mm.

The second, three-dimensional, cellular, thermally conductive structure matches the contour of the wall and extends radially.

The second, three-dimensional, cellular, thermally conductive structure has an outer radius of between 25 mm and 100 mm.

The second, three-dimensional, cellular, thermally conductive structure has a surface opposite the wall with a cylindrical form.

The first, three-dimensional, cellular structure and the second, three-dimensional, cellular structure are in particular secured on said wall.

The first, three-dimensional, cellular structure and the second three-dimensional, cellular structure are in particular structurally heat conductors.

In particular the first and second, three-dimensional, cellular structures define a plurality of cells.

In particular the first and second, three-dimensional, cellular structures have open cells.

In particular, the cells are in communication with one another.

At least one, and in particular each of the three-dimensional, cellular structures comprises a plurality of strands with a thickness of between 1 mm and 3 mm.

At least one, and in particular each of the cellular structures has a level of vacuum of between 85% and 99%.

The level of vacuum of a cellular structure is calculated as follows.

The mass m₁ of the cellular structure is measured in kg.

The cellular structure is placed in a container, and is completely immersed in water which is poured up to a given graduation level. The mass m₂ of the assembly constituted by the cellular structure and the water is measured in kg.

The container is emptied then filled only with water up to said graduation level. The mass m₃ of water is measured in kg.

The volume of the cellular structure Vₛₒₗ is determined in L.

The level of vacuum ε is calculated according to the following equation, where p is the density of the water in kg/L:

$$ɛ = 1 - \frac{{m}_{3} - ( {m}_{2} - {m}_{1} )}{ρ {V}_{sol}} \qquad [ Math . 1 ]$$

At least one, and particular each of the cellular structures has a volume area of between 100 and 1000 m²/m³.

At least one, and in particular each of the cellular structures is a random structure or a regular structure.

Thus, the arrangement of the cells is regular or random.

At least one, and in particular each of the cellular structures is an ordered structure, which is or is not homogenous.

At least one, and in particular each of the cellular structures has Kelvin cells.

At least one, and in particular each of the cellular structures has cells which are not Kelvin cells.

At least one, and in particular each of the cellular structures has cells with geometrical variants relative to one another, the cellular structure(s) being in particular anisotropic.

At least one, and in particular each of the cellular structures has cells which are cylindrical, prismatic or parallelepiped.

At least one, and in particular each of the cellular structures has cells with a polyhedral base, in particular with a base which is octagonal, hexagonal or square.

At least one, and in particular each of the cellular structures has cells described by the registered concept term NEOLATTICE indicated in the documentation developed by the GRIMS Group.

Each cell has a characteristic dimension of between 5 mm and 25 mm

At least one, and in particular each of the cellular structures is a conductive foam, in particular a foam constituted by heat-conductive material.

At least one, and in particular each of the cellular structures is a metal foam or a silicon carbide foam.

At least one, and in particular each of the cellular structures is a foam made of copper, titanium, stainless steel or aluminum, or their alloys.

At least one, and in particular each of the cellular structures is produced by casting or by additive technology.

The foam(s) is/are in particular rigid.

According to another one of its objectives, the invention relates to a method for producing a monobloc assembly as previously described, comprising:
introduction of a liquid into a pre-form;
solidification of the liquid in the pre-form;
removal from the mold of the solid thus obtained, such as to obtain the monobloc assembly.

The monobloc assembly is thus in particular produced by pouring.

The removal from the mold comprises a step of thermal de-coring.

The monobloc assembly is produced by casting.

Alternatively, the monobloc assembly is produced by additive production.

The first, three-dimensional, cellular structure and/or the second, three-dimensional cellular structure can alternatively be rendered integral with the wall by brazing or by welding.

The invention will be able to be better understood by reading the following detailed description of non-limiting embodiments thereof, and by examining the appended drawing, in which:

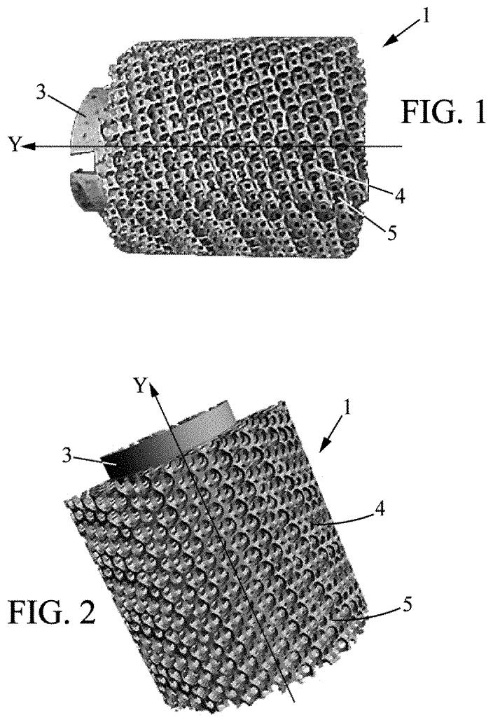

FIG. 1

FIG. 1 represents a monobloc assembly according to the invention.

FIG. 2

FIG. 2 represents the monobloc assembly in FIG. 1 in perspective.

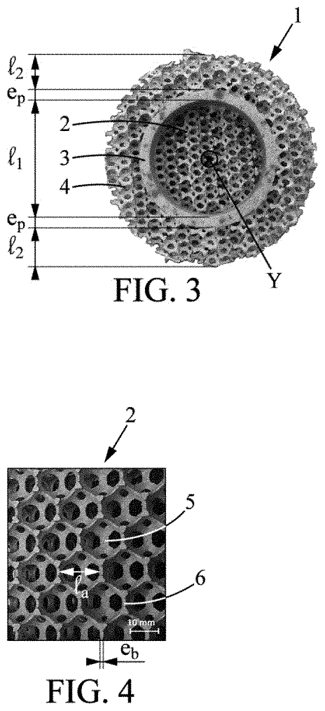

FIG. 3

FIG. 3 is a transverse cross-section of the monobloc assembly in FIG. 1.

FIG. 4

FIG. 4 represents an enlargement of the first, three-dimensional, cellular structure of the monobloc assembly in FIG. 1.

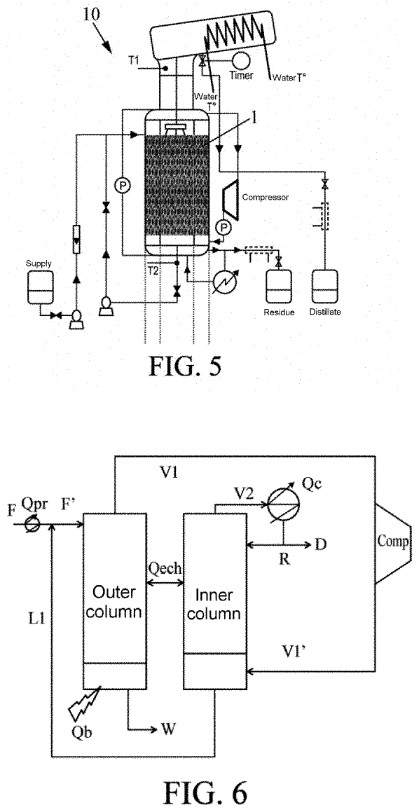

FIG. 5

FIG. 5 represents a device which can carry out transfer of heat according to the invention.

FIG. 6

FIG. 6 represents schematically the operation of an HIDiC column according to the invention.

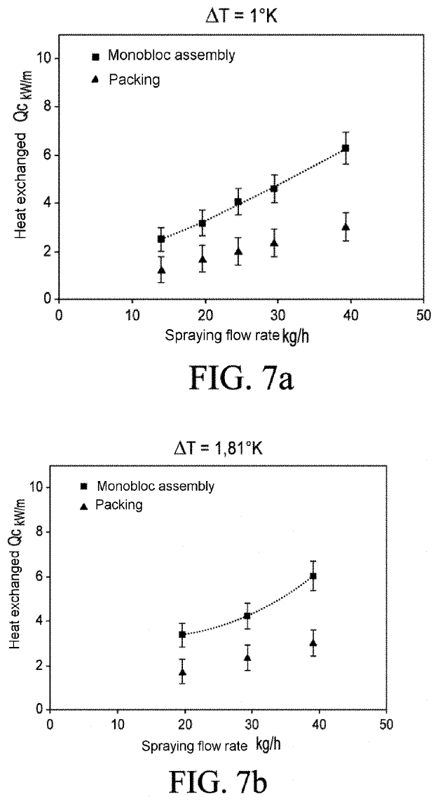

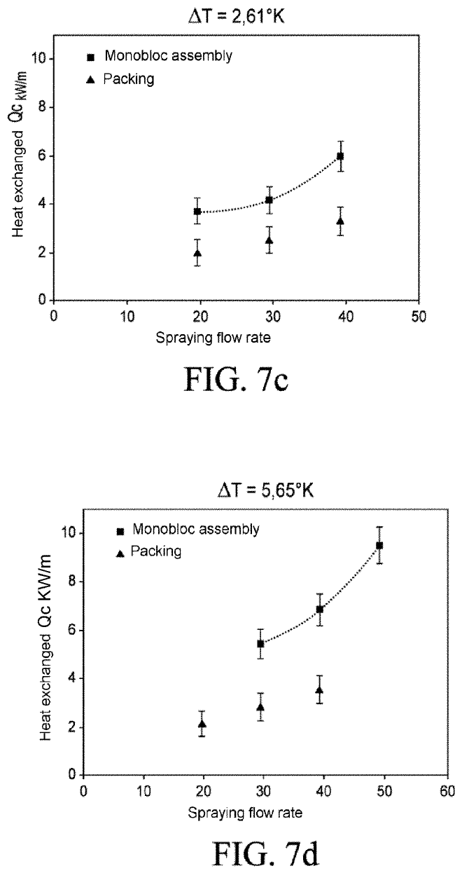

FIG. 7a

FIG. 7a is a first graph comparing the thermal performance of a monobloc assembly according to the invention with packing according to the prior art.

FIG. 7b

FIG. 7b is a second graph comparing the thermal performance of a monobloc assembly according to the invention with packing according to the prior art.

FIG. 7c

FIG. 7c is a third graph comparing the thermal performance of a monobloc assembly according to the invention with packing according to the prior art.

FIG. 7d

FIG. 7d is a fourth graph comparing thermal performance of a monobloc assembly according to the invention with packing according to the prior art.

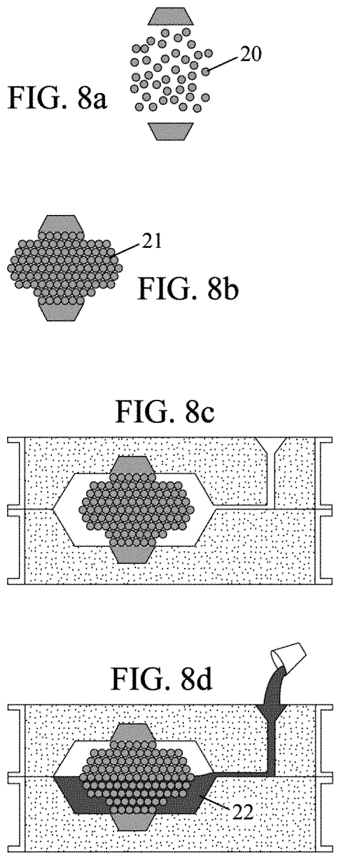

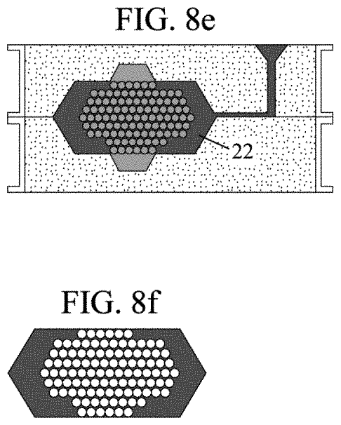

FIG. 8a

FIG. 8a represents a first step of a method for production of a three-dimensional, cellular, thermally conductive structure of a monobloc assembly according to the invention.

FIG. 8b

FIG. 8b represents a second step of a method for production of a three-dimensional, cellular, thermally conductive structure of a monobloc assembly according to the invention.

FIG. 8c

FIG. 8c represents a third step of a method for production of a three-dimensional, cellular, thermally conductive structure of a monobloc assembly according to the invention.

FIG. 8d

FIG. 8d represents a fourth step of a method for production of a three-dimensional, cellular, thermally conductive structure of a monobloc assembly according to the invention.

FIG. 8e

FIG. 8e represents a fifth step of a method for production of a three-dimensional, cellular, thermally conductive structure of a monobloc assembly according to the invention.

FIG. 8f

FIG. 8f represents a sixth step of a method for production of a three-dimensional, cellular, thermally conductive structure of a monobloc assembly according to the invention.

FIGS. 1, 2 and 3 represent a monobloc assembly 1 for a device 10 which can carry out transfer of heat between a first and a second fluid circulating respectively on both sides of a thermally conductive wall 3.

The monobloc assembly 1 comprises:
a first three-dimensional, cellular, thermally conductive structure 2 through which the first fluid can pass;
said wall 3; and
a second, three-dimensional, cellular, thermally conductive structure 4 through which the second fluid can pass.

The first, three-dimensional, cellular structure 2 and the second, three-dimensional, cellular structure 4 are situated on both sides of said wall 3 and are integral with said wall 3.

The heat is transferred from the first fluid to the second fluid through said wall 3.

The first, three-dimensional, cellular structure 2 and the second, three-dimensional, cellular structure 4 comprise a plurality of strands 6 with a thickness e_{b} of between 1 mm and 3 mm.

The wall 3 has a cylindrical form around an axis Y.

The wall 3 has a thickness eₚ of 5 mm.

The first, three-dimensional, cellular, thermally conductive structure 2 fills the interior of the cylinder formed by the wall 3.

The second, three-dimensional, cellular, thermally conductive structure 4 matches the contour of the wall 3 and extends radially.

The surface of the second, three-dimensional, cellular, thermally conductive structure 4 opposite the wall 3 has a cylindrical form around the axis Y.

The first, three-dimensional, cellular structure 2 has a diameter I₁ of 80 mm.

The second, three-dimensional, cellular structure 4 has a radial dimension I₂ of 25 mm.

As illustrated in FIG. 4, each cell 5 has a characteristic dimension Iₐ of 10 mm.

The first and second cellular structures 2, 4 are metal foams with Kelvin cells.

FIG. 5 represents a device 10 according to the invention. The device 10 is a concentric HIDiC column comprising a monobloc assembly 1 according to the invention.

The device 10 comprises an enrichment column, known as the inner column, comprising a first, three-dimensional, cellular, thermally conductive structure 2, and an impoverishment column, known as the outer column, comprising a second, three-dimensional, cellular, thermally conductive structure 4, the enrichment column and the impoverishment column being concentric.

The thermal performance levels of a monobloc assembly 1 according to the invention were tested on a concentric HIDiC column and compared with packing according to the prior art in FIGS. 7a, 7b, 7c and 7d.

On both sides of the wall, the monobloc assembly 1 tested comprises an aluminum metal foam with a level of vacuum of 85%, and having Kelvin cells.

The packing according to the prior art is “super ring” packing sold by the company Raschig Gmbh.

The concentric HIDiC column on which the tests were carried out is a column one meter high comprising an inner column with a diameter of 80 mm and an outer column with a diameter of 150 mm.

The inner column is supplied with cyclohexane at a flow rate, known as the “spraying flow rate”, of 12 kg/h to 40 kg/h.

The outer column is supplied with water vapor at a flow rate of 0.8 kg/h to 5 kg/h, at a pressure of between 1.8 atm and 2.2 atm.

FIGS. 7a, 7b, 7c and 7d represent the heat exchanged according to the spraying flow rate for the monobloc assembly 1 on the other hand and for the packing according to the prior art, known as the “packing” on the other hand, respectively for a temperature difference on both sides of the wall ΔT of 1° K, 1.81° K, 2.61° K, and 5.65° K.

The results given in FIGS. 7a, 7b, 7c and 7d show that the monobloc assembly 1 according to the invention provides better thermal performance than the packing according to the prior art.

The mean value of the gain is approximately 100%: the monobloc assembly 1 according to the invention doubles the heat exchange in comparison with the packing according to the prior art.

In addition, three tests were carried out on a concentric HIDiC column according to the invention, represented highly schematically in FIG. 6, comprising a monobloc assembly 1 according to the invention.

The monobloc assembly 1 used for these three tests comprises, on both sides of the wall 3, an aluminum foam with a level of vacuum of 85%, and having

Kelvin cells.

For each test, the results were analyzed with the n-heptane (C7)/cyclohexane (C6) system. The three tests (tests 1, 2 and 3) were carried out respectively with a pressure in the inner column Pint of 1.3 bar, 1.5 bar and 1.5 bar. All of the results are summarized in tables 1 to 3, corresponding respectively to tests 1 to 3, with the values measured being represented in FIG. 6.

TABLE 1

| | | F | W | D | F′ | V1 | V1′ | L1 | V2 |
|---|---|---|---|---|---|---|---|---|---|
| Total flow | kg/h | 11.80 | 3.00 | 8.80 | 24.30 | 21.30 | 21.30 | 12.51 | 8.80 |
| rate | | | | | | | | | |
| Mass | C6 | 0.49 | 0.12 | 0.62 | 0.44 | 0.49 | 0.49 | 0.39 | 0.62 |
| fraction | C7 | 0.51 | 0.88 | 0.38 | 0.56 | 0.51 | 0.51 | 0.61 | 0.38 |
| Temperature | ° C. | 29.57 | 95.66 | 95.83 | 84.72 | 89.21 | 101.08 | 97.23 | 91.08 |
| Pressure | bar | 1.01 | 1.01 | 1.35 | 1.01 | 1.01 | 1.35 | 1.35 | 1.35 |

TABLE 2

| | | F | W | D | F′ | V1 | V1′ | L1 | V2 |
|---|---|---|---|---|---|---|---|---|---|
| Total flow | kg/h | 11.75 | 10.82 | 0.92 | 28.92 | 18.10 | 18.10 | 17.18 | 0.92 |
| rate | | | | | | | | | |
| Mass | C6 | 0.47 | 0.43 | 0.94 | 0.61 | 0.71 | 0.71 | 0.70 | 0.94 |
| fraction | C7 | 0.53 | 0.57 | 0.06 | 0.39 | 0.29 | 0.29 | 0.30 | 0.06 |
| Temperature | ° C. | 39.88 | 87.88 | 95.22 | 84.71 | 84.65 | 98.57 | 93.78 | 83.99 |
| Pressure | bar | 1.01 | 1.01 | 1.50 | 1.01 | 1.01 | 1.50 | 1.50 | 1.50 |

TABLE 3

| | | F | W | D | F′ | V1 | V1′ | L1 | V2 |
|---|---|---|---|---|---|---|---|---|---|
| Total flow | kg/h | 11.4 | 2.8 | 8.6 | 18.7 | 15.9 | 15.9 | 7.3 | 8.6 |
| rate | | | | | | | | | |
| Mass | C6 | 0.5 | 0.1 | 0.6 | 0.4 | 0.5 | 0.5 | 0.4 | 0.6 |
| fraction | C7 | 0.5 | 0.9 | 0.4 | 0.6 | 0.5 | 0.5 | 0.6 | 0.4 |
| Temperature | ° C. | 31.5 | 95.5 | 100.1 | 84.8 | 89.4 | 105.4 | 100.6 | 89.9 |
| Pressure | bar | 1.0 | 1.0 | 1.5 | 1.0 | 1.0 | 1.5 | 1.5 | 1.5 |

The results of the tests were compared with the results of a conventional distillation column.

The power to be supplied to the boiler of the conventional distillation column (conventional Qb) was compared with the power supplied to the boiler of the HIDiC column (HIDiC Qb) added to the power consumed by the compressor of the HIDiC column (Pcomp).

The pessimistic hypothesis according to which the isentropic performance of the compressor of the HIDiC column is 25% was adopted.

The results are contained in table 4.

TABLE 4

| | | | | Total | | |
|---|---|---|---|---|---|---|
| | HIDiC | Pcomp (KW) | Pcomp (kW) | HIDiC | Conventional | |
| | Qb (kW) | (isentropic) | (25% isentropic) | (kW) | Qb (kW) | Gain |
| Test 1 | 0.31 | 0.06 | 0.24 | 0.55 | 0.97 | 43% |
| Test 2 | 0.04 | 0.07 | 0.28 | 0.32 | 0.52 | 57% |
| Test 3 | 0.3 | 0.06 | 0.24 | 0.54 | 0.84 | 36% |

Energy gains of between 36% and 57% were obtained.

The use of an HIDiC column according to the invention thus makes possible a clear energy gain in comparison with a conventional distillation column.

FIGS. 8a, 8b, 8c, 8d, 8e and 8f represent different steps of a method for production of a three-dimensional, cellular, thermally conductive structure of a monobloc assembly according to the invention.

The three-dimensional cellular structure is produced by boiler making techniques.

Plate cores 20 are produced (FIG. 8a). The pattern which constitutes the cores 20 is for example a Kelvin cell on which the ridges have been chamfered in order to permit infiltration of the metal. The cores 20 are based on sand.

The cores 20 are agglomerated in a pre-form 21 (FIG. 8b). The cores 20 are arranged by imbrication of the plates.

A mold is produced and the pre-form 21 is re-molded (FIG. 8c).

A bath 22 of metal, for example aluminum, is prepared, then the liquid metal 22 is infiltrated into the pre-form (FIG. 8d). The filling system and the temperature of the metal are adapted to the configuration of the three-dimensional cellular structure to be produced. Software which makes it possible to calculate the distances of infiltration of metal can be used.

The metal is solidified (FIG. 8e).

The sand is discharged by means of a thermal de-coring process which makes it possible to discharge the sand without damaging the strands (FIG. 8f).

The metal is finished, and the three-dimensional cellular structure is produced.

The method for production of the three-dimensional cellular structure comprises checking of the form of the cores, checking of the porosity of the metal before casting, measurement of the temperature of the metal before casting, verification of the metallurgy of the metal before casting, in particular by means of a spectrometer, and visual checking after removal of the sand.

1-18. (canceled)

19. A method for transfer of heat between a first and a second fluid, wherein the first and the second fluid circulate respectively on both sides of a thermally conductive wall of a monobloc assembly formed in a single piece, which assembly is arranged in the interior of a device, the monobloc assembly comprising:
a first, three-dimensional, cellular, thermally conductive structure through which the first fluid can pass;
at least said wall; and
a second, three-dimensional, cellular, thermally conductive structure through which the second fluid can pass;
the first, three-dimensional, cellular structure and the second, three-dimensional, cellular structure being situated on both sides of said wall and being integral with said wall;
such that the transfer of heat is carried out from the first fluid to the second fluid through said wall, and each of the first and second fluids is both under liquid phase and under gaseous phase, with the liquid phase of the first fluid circulating in a direction opposite that of the gaseous phase of the first fluid, and the liquid phase of the second fluid circulating in a direction opposite that of the gaseous phase of the second fluid.

20. The method for transfer of heat as claimed in claim 19, the speed of the gaseous phase of each of the first and second fluids being between 0.5 m/s and 5 m/s, preferably between 1 m/s and 3 m/s.

21. The method for transfer of heat as claimed in claim 19, wherein material is transferred simultaneously with the transfer of heat.

22. A device which can carry out transfer of heat between a first and a second fluid circulating respectively on both sides of a thermally conductive wall, said device being configured to implement the method as claimed in claim 19, the device comprising a monobloc assembly formed in a single piece comprising:
a first, three-dimensional, cellular, thermally conductive structure through which the first fluid can pass;
at least said wall; and
a second, three-dimensional, cellular, thermally conductive structure through which the second fluid can pass;
the first, three-dimensional, cellular structure and the second, three-dimensional, cellular structure being situated on both sides of said wall and being integral with said wall;
such that the transfer of heat is carried out from the first fluid to the second fluid through said wall.

23. The device as claimed in claim 22, the device being a distillation column, an absorption column, a stripping column or a heat exchanger.

24. The device as claimed in claim 22, the device being an HIDiC distillation column, in particular a concentric HIDiC distillation column.

25. A monobloc assembly designed for the implementation of a method as claimed in claim 19, said monobloc assembly being designed to be arranged in the interior of a device configured to implement said method, which can carry out transfer of heat between a first and a second fluid circulating respectively on both sides of a thermally conductive wall, said monobloc assembly being formed in a single piece and comprising:
a first, three-dimensional, cellular, thermally conductive structure through which the first fluid can pass;
at least said wall; and
a second, three-dimensional, cellular, thermally conductive structure through which the second fluid can pass;
the first, three-dimensional, cellular structure and the second, three-dimensional, cellular structure being situated on both sides of said wall and being integral with said wall;
such that the transfer of heat is carried out from the first fluid to the second fluid through said wall.

26. The monobloc assembly as claimed in claim 25, the wall having a cylindrical form.

27. The monobloc assembly as claimed in claim 26, the first three-dimensional, cellular, thermally conductive structure filling the interior of the cylinder formed by the wall, and the second, three-dimensional, cellular, thermally conductive structure matching the contour of the wall and extending radially.

28. The monobloc assembly as claimed in claim 27, the second, three-dimensional, cellular, thermally conductive structure having a surface opposite the wall with a cylindrical form.

29. The monobloc assembly as claimed in claim 25, at least one, and in particular each of the cellular structures comprising a plurality of strands with a thickness of between 1 mm and 3 mm.

30. The monobloc assembly as claimed in claim 25, at least one, and in particular each of the cellular structures having a level of vacuum of between 85% and 99%.

31. The monobloc assembly as claimed in claim 25, at least one, and particular each of the cellular structures having a volume area of between 100 and 1000 m²/m³.

32. The monobloc assembly as claimed in claim 25, at least one, and in particular each of the cellular structures being a regular structure.

33. The monobloc assembly as claimed in claim 25, at least one, and in particular each of the cellular structures having Kelvin cells and/or cells which are not Kelvin cells.

34. The monobloc assembly as claimed in claim 25, at least one, and in particular each of the cellular structures being a metal foam or a silicon carbide foam, in particular a foam made of copper, titanium, stainless steel or aluminum.

35. A method for producing a monobloc assembly as claimed in claim 25, comprising:
introduction of a liquid into a pre-form;
solidification of the liquid in the pre-form;
removal from the mold of the solid thus obtained, such as to obtain the monobloc assembly.

36. The method as claimed in claim 35, with the removal from the mold comprising a step of thermal de-coring.
